(19) United States
(12) Patent Application Publication
(10) Pub. No.: US 2024/0146201 A1
(43) Pub. Date: May 2, 2024

(54) AN ELECTRICAL SWITCHED MODE POWER CONVERTER AND OPERATIVE PROCEDURE THEREOF

(71) Applicant: Differential Power, SL, Madrid (ES)

(72) Inventor: Jose Antonio Cobos Marquez, Madrid (ES)

(73) Assignee: Differential Power, SL, Madrid (ES)

(21) Appl. No.: 18/548,593

(22) PCT Filed: Mar. 4, 2022
(86) PCT No.: PCT/EP2022/055560

§ 371 Date: Sep. 1, 2023

(30) Foreign Application Priority Data
Mar. 4, 2021 (EP) 21382181.2

(51) Int. Cl. H02M 3/335; H02M 1/00

(52) U.S. Cl. CPC H02M 3/33571; H02M 1/0025; H02M 1/0058; H02M 3/33584

(57) ABSTRACT

An electrical switched-mode power converter (1) and a method to operate it

The power converter has some power switches, two DC ports (201, 202), in which power in each port (201, 202) may flow uni-directionally or bi-directionally, controlled by the duty cycle (d) of the power switches and including at least an inductance Lₘ (4) whose voltage waveform alternates between a positive (V⁺) and a negative (V⁻) values at the switching frequency of the converter and its mean value is zero in steady state. The power converter includes an additional DC port (200) connected to said inductance Lₘ (4), said DC port (200) with uni-directional or bi-directional power flow, comprising a controlled or un-controlled power switch (6), a second inductance Lₛ₂ (7) operated to control the mean value of its current and an output capacitor (8) wherein the voltage of the additional DC port (200) is controlled by the switching frequency (f) of the power converter. The switching frequency and duty cycle of the power converter are controlled to provide a power flow according to three operative power pathways.

### TECHNICAL FIELD

The present invention refers to the field of the electrical switched-mode power converters and in a more specific way to an electrical switched-mode power converter that includes two DC ports: an input port and an output port in which power in each port may flow uni-directionally or bi-directionally, controlled by the duty cycle (d) of some power switches of the power converter and including at least an inductance, Lₘ whose voltage waveform alternates between a positive (V⁺) and a negative (V⁻) value at the switching frequency of the converter and its mean value is zero in steady state.

### BACKGROUND OF THE INVENTION

It is known in prior art [1] that a Switched Mode Power Supply, SMPS may regulate independently two output voltages to supply two different loads. The inductor of one output operates in Continuous Conduction Mode (CCM) and is regulated by adjusting the duty cycle of the main power switch. The inductor of the other output operates in Discontinuous Conduction Mode (DCM) and is regulated by adjusting the switching frequency of the power converter. This is known as duty cycle-switching frequency control (d-f control).

It is also known in prior art that a Buck converter, which is a 2-port power converter with a single energy source and a single load in which the output voltage is lower than the input voltage, may embed an additional secondary output attached to the inductor of the buck converter, operating in “Flyback” mode. The name in the literature for the resulting circuit is “Fly-buck converter”[2,3]. This output is typically generated to supply auxiliary circuitry of the power converter, generating an auxiliary voltage which is proportional to the main output. The additional output is not independently regulated, just the opposite. The goal is to maintain proportionality and restrain cross-regulation. In fact, the leakage inductance of the transformer is minimized to maintain proportionality. There is only one control parameter, not two. In some variations, an additional controlled switch is added in the additional output to maintain the proportionality between the outputs, by delaying the conduction of this branch.

It is also known in prior art that a half-bridge converter may be combined with a flyback converter to obtain the “Asymmetrical Half-Bridge Flyback converter”, also known as “Resonant Hybrid Flyback” converter [4-5]. This circuit operates with resonant current, produced by a resonant capacitor in series with the transformer and a resonant inductor, which is located in primary side of the transformer. This leakage inductor may be the leakage inductance of the transformer in the primary winding. There is only one control parameter, used to control the output voltage of the converter. This converter is widely used in AC-DC adapters. The input capacitor is large enough to perform energy storage at line frequency (50 Hz or 60 Hz). The mean voltage of the resonant capacitor is not controlled because its voltage is the mean voltage of the voltage in the power switch, which does not change.

US2012063175 A1 discloses a circuit for use with a synchronous rectifier (SR) driver of a power converter, comprising a non-linear compensation circuit connected across the SR, wherein a voltage of the non-linear compensation circuit is outputted to the SR driver and used by the SR driver to generate a driving signal for the SR. FIG. 2B is a circuit diagram of an example of a conventional half-bridge LLC resonant converter with SRs, allowing to observe, in spite of an apparent similarity with the embodiment of FIG. 10 of this invention, that in US2012063175 A1 the resonant capacitor is not a DC port of the converter, hence its voltage cannot be controlled and the power flow is zero. Moreover, US2012063175 A1 in fact is a 2-port converter not a 3-port converter as proposed by this invention.

Document [6] discloses an electrical switched-mode power converter (see abstract and FIG. 1) including some power switches (S1, S2, S3, S4) and two DC ports (for respectively V_{bat} and V_{PV}) in which power in each port may flow uni-directionally (for V_{PV})) or bi-directionally (for V_{bat}) since it is a stand-alone system controlled by the duty cycle (“D”, see e.g. FIG. 2) of the power switches and including at least an additional inductance Lₘ, to configure an additional DC port (for V₀) connected to said inductance Lₘ.

However, unlike what is proposed in this invention the additional DC port (for V₀) is a resonant additional output, not a PWM (square voltages and triangular currents) and although V₀, i.e., Vₒᵤₜ is controlled by the switching frequency of the converter, the performance (including the gain) of a resonant converter is different from the voltage and current waveforms shown in FIG. 14.

Moreover, there is no Lₘ in the converter between V_{bat} and V_{PV} since the transformer including Lₘ and resonant network are added to the bridge Uₜₐₙₖ. The power converter between V_{bat} and V_{PV} is configured as two bi-directional synchronous buck/boost with a 180° phase shift. There is no Lₘ in this converter because there is even no transformer in the power converter between V_{bat} and V_{PV}.

Furthermore, the voltage U_{LM} in the referred Lₘ is not square see FIG. 2 of document [6], where linear sections can be seen in the transitions from a positive to a negative value of the said voltage.

Whether in document [6] the two main ports were considered (for respectively V_{bat} and Vₒ) second port, i.e., output port, includes four switches, a transformer and a rectifier, i.e., as indicated above, it is a resonant converter therefore totally different from the proposal of this invention, moreover the additional port is not connected to the transformer magnetizing inductance.

### REFERENCES

[1] J. Sebastian and J. Uceda, “The double converter: A fully regulated two-output dc-to-dc converter,” 1985 IEEE Power Electronics Specialists Conference, Toulouse, France, 1985, pp. 117-126, doi: 10.1109/PESC.1985.7070936.

[2] S. B. Myneni and S. Samanta, “A Comparative Study of Different Control strategies for Isolated Buck (Fly-Buck) Converter,” 2018 IEEE International Conference on Power Electronics, Drives and Energy Systems (PEDES), Chennai, India, 2018, pp. 1-5, doi: 10.1109/PEDES.2018.8707754.

[3] Wu Wang et al., “Analysis of Fly-buck converter with emphasis on its cross-regulation” I ET 2016, pp. 1-5, doi: 10.149/iet-pel2016.0272

[4] Tso-Min Chen and Chern-Lin Chen, “Characterization of asymmetrical half bridge flyback converter,” 2002 IEEE 33rd Annual IEEE Power Electronics Specialists Conference. Proceedings (Cat. No.02CH37289), Cairns, QLD, Australia, 2002, pp. 921-926 vol.2, doi: 10.1109/PSEC.2002.1022572.

[5] Medina-Garcia, A.; Schlenk, M.; Morales, D.P.; Rodriguez, N. Resonant Hybrid Flyback, a New Topology for High Density Power Adaptors. Electronics 2018, 7, 363.

[6] Xiaofeng Sun, Yanfeng Shen, Wuying Li, A novel LLC integrated three-port DC-DC converter for stand-alone PV/battery system. IEE CONFERENCE AND EXPO TRANSPORTATION ELECTRIFICATION ASIA-PACIFIC (ITEC ASIA-PACIFIC), IEE, 21 August 2014 (2014-08-31) pages 1-6, XP032671730.

### BRIEF DESCRIPTION OF THE INVENTION

This invention proposes an electrical switched-mode power converter 1, including some power switches and two DC ports 201, 202 wherein power in each port 201, 202 may flow uni-directionally or bi-directionally, controlled by the duty cycle (d) of the power switches and further including an inductance Lₘ 4 whose voltage waveform alternates between a positive V⁺ and a negative V⁻ values at the switching frequency of the converter and its mean value is zero in steady state all in accordance with the cited state of the art and is characterized in that it includes an additional DC port 200 that is connected to the inductance Lₘ 4.

In another optional embodiment of the invention the voltage in the magnetizing inductance of the transformer has a time interval in which the voltage is a zero-volt interval or includes a resonant transition.

This additional DC port 200 with uni-directional or bi-directional power flow, comprises a controlled or un-controlled power switch 6, a second inductance Lₛ₂ 7 operating in Discontinuous Conduction Mode (DCM) and an output capacitor 8. The voltage of the additional DC port 200 is controlled by the switching frequency (f) of the power converter. Optionally, the current in Lₛ₂ may be commanded by a capacitance 82 or an active clamp capacitance 92 so that the RMS value of the current flowing through the additional port 200 is reduced, maintaining the frequency control of the output voltage. In either case, the output voltage of the port is obtained multiplying the load resistance by the mean value of the current flowing by Lₛ₂. In this case Lₛ₂ is not operated in Discontinuous Conduction Mode (DCM).

In an embodiment a capacitance 82 and/or a clamping capacitance 92 and a clamping switch 62 are connected in parallel with the power terminals of the referred controlled or un-controlled power switch 6. Such an arrangement can ensure that the conduction time of the power switch 6 be maximized to reduce the RMS value of the current, said conduction time being adjusted to operate the power switch 6 close to its technological limit, that is, its maximum breakdown voltage.

As per another embodiment the electrical switched-mode power converter 1, further includes an additional inductance Lₛ₁ 15.

In still another embodiment the additional DC port 200 of the electrical switched-mode power converter 1 further includes a transformer 20 that provides isolation to the additional port 200 wherein magnetizing and leakage inductances of the transformer 20 contribute or completely replace inductances Lₘ 4, Lₛ₁ 15 and Lₛ₂ 7.

Also in one embodiment one of these two DC ports 201, 202 and the additional DC port 200 is connected to an energy source 10 wherein this energy source 10 may be a DC voltage or a low frequency AC voltage with regard the switching frequency and a load 12 is connected to the other remaining two ports wherein their voltages are independently controlled by the duty cycle and by the switching frequency of the converter.

In another embodiment two of the DC ports of these two DC ports 201, 202 and the additional

DC port 200 are connected to energy sources 10 wherein these energy sources are either a DC voltage or a low frequency AC voltage with regard to the switching frequency, and a load 12 is connected to the other remaining port wherein this load 12 receives power from said two energy sources 10, said power being independently controlled by the duty cycle and by the switching frequency of the converter.

Still in another embodiment one of the DC ports of these two DC ports 201, 202 and the additional DC port 200 is connected to an energy source 10 that may be a DC voltage or a low frequency AC voltage with regard to the switching frequency, wherein anyone of the two other remaining ports 201, 202 is used as energy storage 11 providing a two-port energy buffered power converter in which stored energy changes at a rate controlled either by a selected duty cycle or by a selected switching frequency of the converter and the third remaining port is connected to a load 12 wherein the voltage of this load 12 is regulated by the non-selected switching frequency or by the non-selected duty cycle of the converter.

With regard to the duty cycle and the switching frequency they are configured to control the DC voltage of the load 12 and to shape the input current in the AC or rectified AC port whereby reducing the harmonic content of the input current waveform.

In an embodiment one of the two DC ports 201, 202 is connected through a rectifier bridge to an AC voltage and the additional DC port 200 is connected to a load 12, wherein the duty cycle controls the shape of the input current and wherein the amplitude of this input current is adjusted by regulating the mean voltage of the remaining DC port connected to the energy storage 11, wherein the power topology connecting these two DC ports 201, 202 is a synchronous buck converter and the voltage applied to the load 12 is regulated by the switching frequency.

As per another embodiment the additional DC port 200 comprises a bi-directional power switch 6 and is connected to an AC voltage and anyone of the two other DC ports 201, 202 is used as an energy storage 11 and the other remaining port is connected to a load 12, and the switching frequency controls the shape of the input current wherein the amplitude of this input current is adjusted by regulating the mean voltage of the DC port 201, 202 used as energy storage 11, wherein the power topology connecting these two DC ports 201, 202 is a synchronous buck converter and the voltage applied to the load 12 is regulated by the duty cycle.

The invention also refers to a method to operate an electrical switched-mode power converter 1, with the improvements as described up to this point, wherein the switching frequency and duty cycle are controlled to provide a power flow according to three operative power pathways:
A. from AC input port 202 the power flows to the load port 200 and to the energy storage port 201; this mode applies for AC input voltage higher than a given threshold;
B. from AC input port 202 and the Energy storage port 201 the power flows to a load port 200; this mode applies when the input power is lower than the power demanded by the load; and
C. from the energy storage port 201 the power flows to a load port 200; this mode applies for AC input voltage lower than a given threshold.

Moreover, as per the proposed method the mean voltage in the energy storage 11 port is adjusted according to the RMS or peak voltage of the AC port, hence reducing power losses and improving power converter performance.

In addition to the above, transitions between exposed modes and operation of the electrical switched-mode power converter 1 are made according to the following patterns:
from mode A to B and from B to A, these two transitions do not require any specific action from the control circuitry; the duty cycle controls the desired input current shape, i.e. to meet the power factor correction regulations or low frequency harmonics standards and its amplitude, to take from the input the same power as the power delivered to the output; the latter is achieved by controlling the mean value of the voltage in the energy storage port; the switching frequency controls the output voltage in the additional port 200;
from mode B to C, the time instant at which the transition occurs is when v₂−v₁<V_{threshold_BC}; from that moment on, the port 202 does not supply nor drains any power; its function is just to demagnetize Lₘ; the voltage in port 202 is adjusted by the duty cycle of the converter, D_{idle}, which may be selected to optimize the performance of the converter, i.e., the efficiency; and
from mode C to B, the time at which the transition occurs is when v₂−v₁>V_{threshold_CB};

from that moment on, the port 202 supplies power again; the duty cycle of the converter is controlled to adjust the shape and amplitude of the input current, as in mode A.

### BRIEF DESCRIPTION OF THE FIGURES

FIG. 1 shows a diagram of a switched mode power converter with two outputs, according to the state of the art in which the two outputs are independently controlled by means of the duty cycle and the switching frequency.

FIG. 2 illustrates a buck converter with an additional output, operating in fly-buck mode known in the previous art.

FIG. 3 discloses a known arrangement of a circuit also known in the art, which may be described as an “Hybrid Flyback” or an “Asymmetrical Resonant Half Bridge”.

FIGS. 4A illustrates an embodiment of a switched mode power converter according to this invention in which an additional DC port, that is illustrated more in detail in FIG. 4B is incorporated.

FIG. 4B shows the minimum or basic components of additional DC port to be added to the embodiment of FIG. 4A including a controlled or uncontrolled power switch and a second inductance. The second inductance is operated to control the mean value of its current. The controlled or uncontrolled power switch may be unidirectional or bi-directional.

FIG. 4C is equivalent to FIG. 4B but showing the cited alternative embodiment further including a capacitance 82 connected in parallel and/or a clamping capacitance 92 and a clamping switch 62 connected in parallel with the power terminals of the controlled or uncontrolled power switch of the additional DC port. The cited capacitance and/or clamping capacitance and clamping switch which are optional have been included inside a box in a dotted line labeled Z.

FIG. 4D schematically shows the result of the incorporation of the additional port providing this invention.

FIG. 5 illustrates another embodiment of this invention with the addition of the inductance Lₛ₁.

FIG. 6A illustrates the previous embodiment with the addition of an ideal transformer 20. The circuit operates as with a real transformer 20 embedding inductances Lₘ, Lₛ₁ and Lₛ₂, as illustrated in FIG. 6B.

FIGS. 7A to 7C illustrate different configurations of the switched mode power converter according to this invention arranged to supply two different loads, independently regulated by the duty cycle and by the switching frequency.

FIG. 8 shows an embodiment of the switched mode power converter according to this invention configured to supply one single load, which receives energy from two different energy sources. The power supplied by these two sources is controlled by the duty cycle (d) of the power switches and by the switching frequency (f) of the power converter.

FIGS. 9A to 9E disclose some embodiments illustrating that the switched mode power converter of this invention may be configured to include an energy buffer.

FIG. 10 shows an embodiment of the switched mode power converter of this invention based on a synchronous buck converter to regulate the voltage gain and the power flow between port 202 and port 201 and whereas the DC port 201 is connected to an energy buffer, which may absorb or deliver power at a frequency orders of magnitude lower than the switching frequency of the power converter.

FIGS. 11A and 11B show two embodiments of the switched mode power converter of this invention in which an AC energy source is connected to port 200.

FIG. 12 shows an embodiment of the switched mode power converter of this invention, where a synchronous buck converter regulates the voltage gain and the power flow between port 202 and port 201 and a DC energy source is connected to port 200.

In FIG. 13 the key waveforms describing the operation of the switched mode power converter of this invention have been represented. The additional port 200 may operate in any of the 4 quadrants with regard to voltage and power (a1, a2, b1, b2).

FIG. 14A shows a specific embodiment of this invention, wherein the power converter 1 is a synchronous buck, and the power switch in the additional port is a diode. This converter is also the equivalent circuit of the embodiment corresponding to claim 8, shown in FIG. 10.

FIG. 14B to 14F illustrate the conduction timing of the three power switches together with the voltage V_{Ls2} that drives the current in the inductance Ls2.

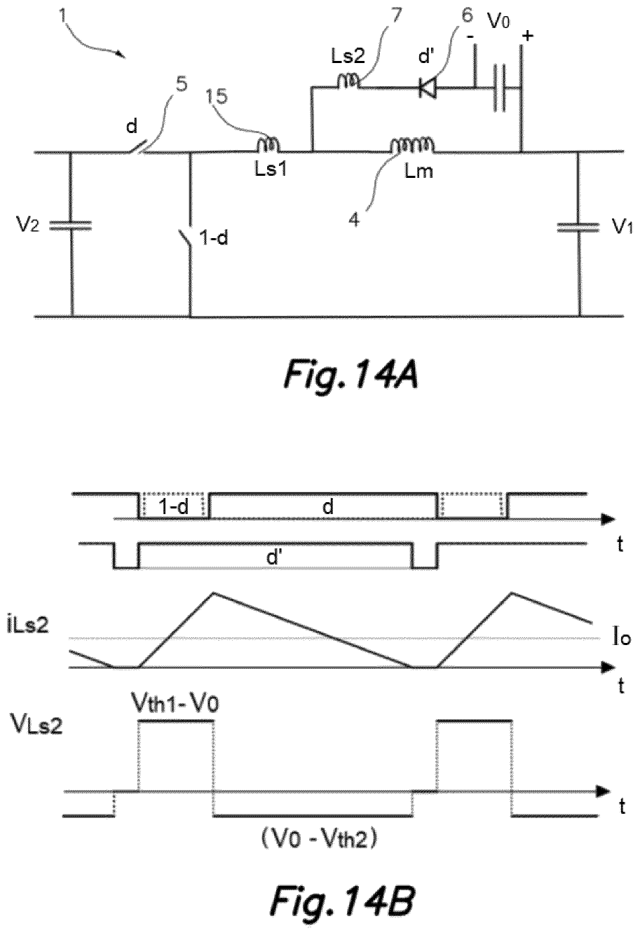

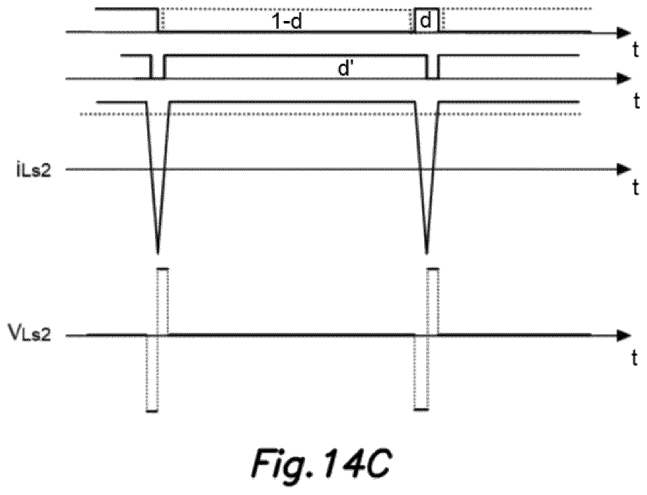

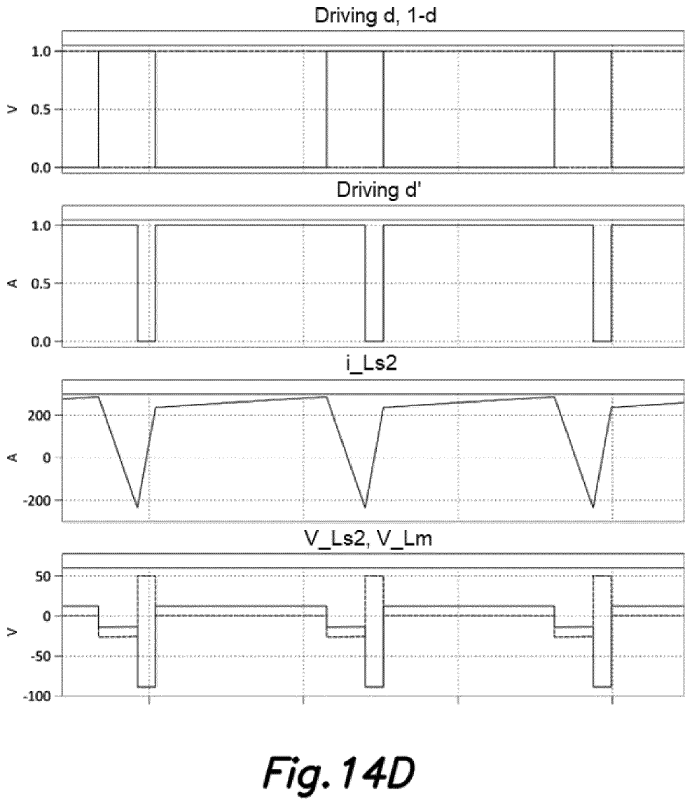

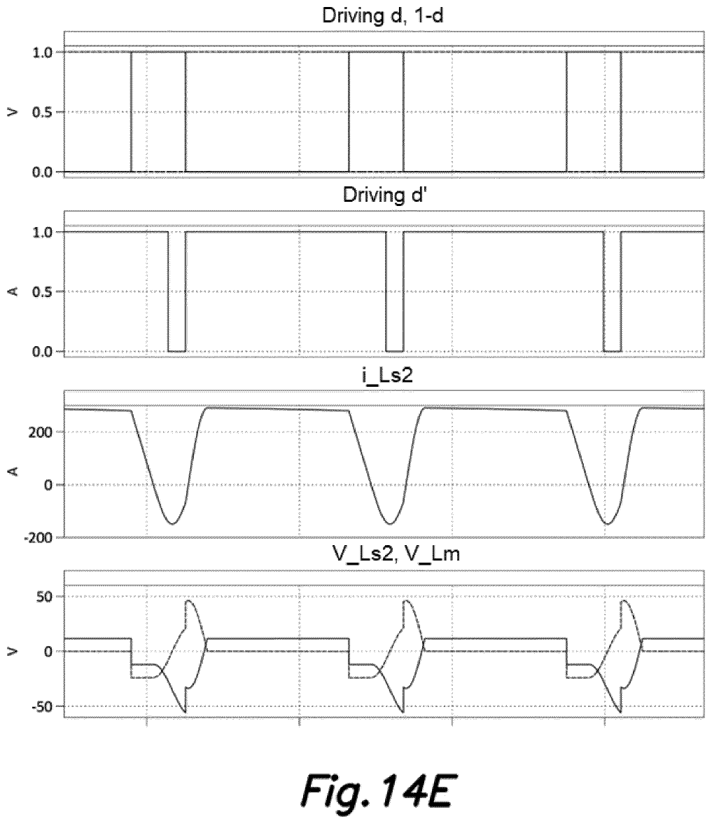

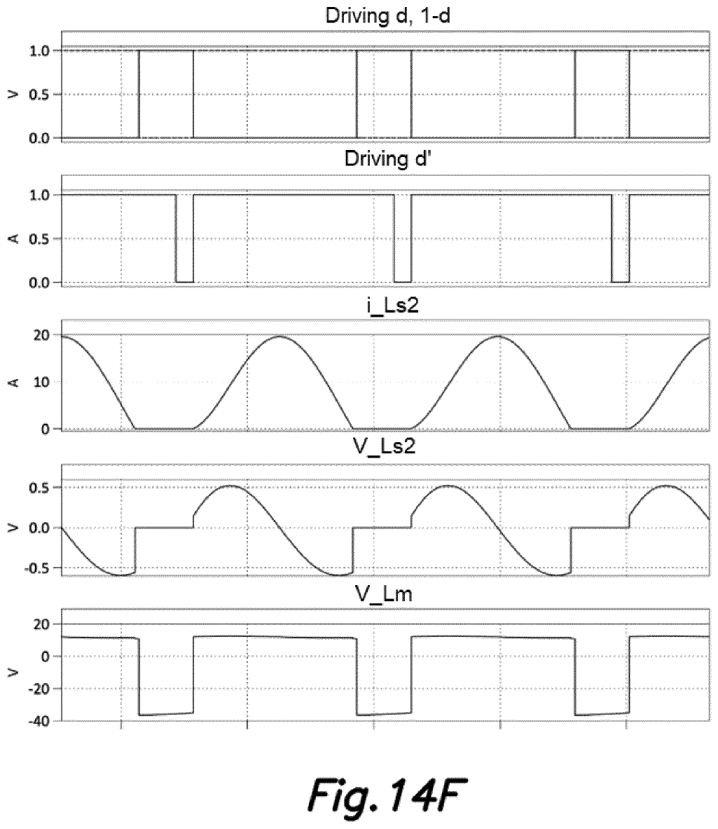

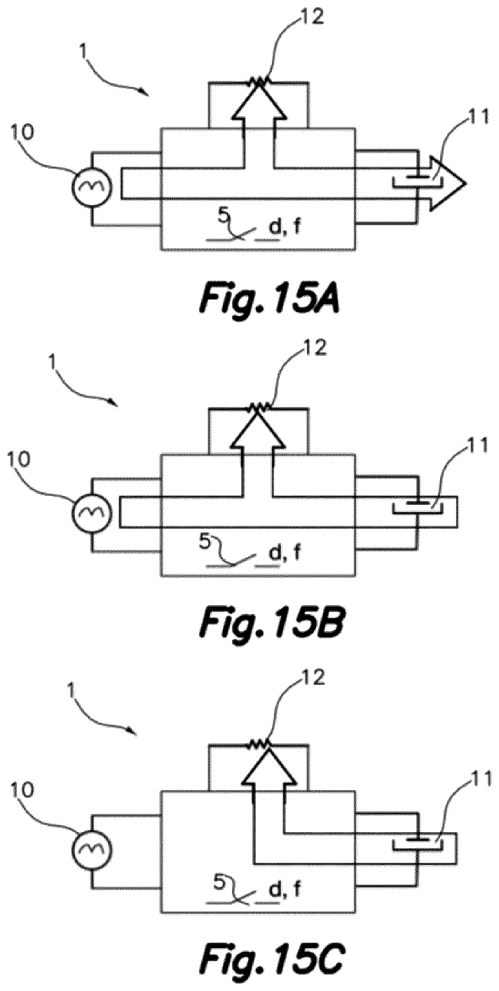

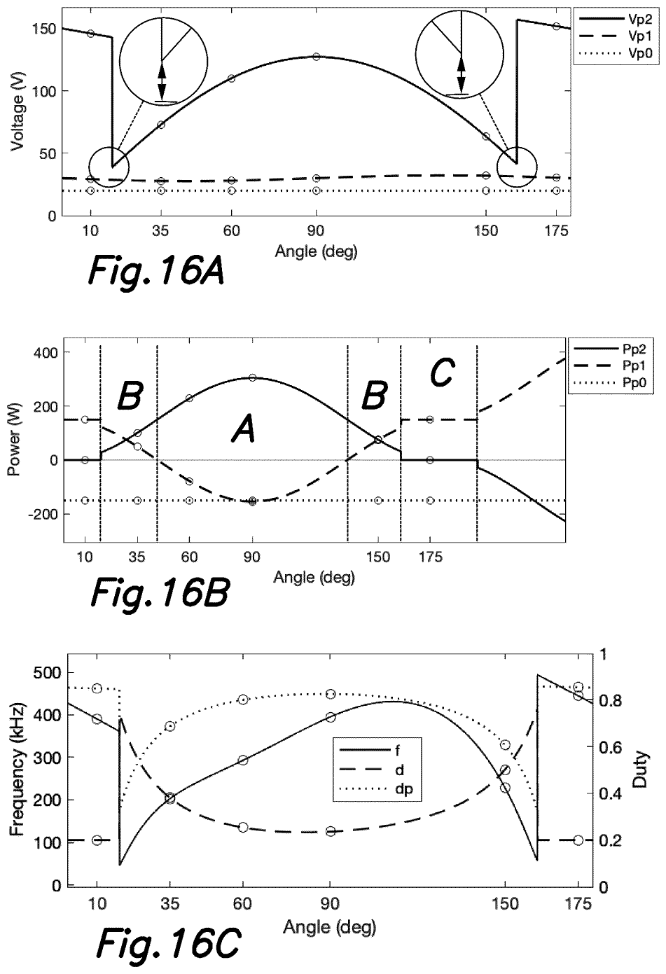

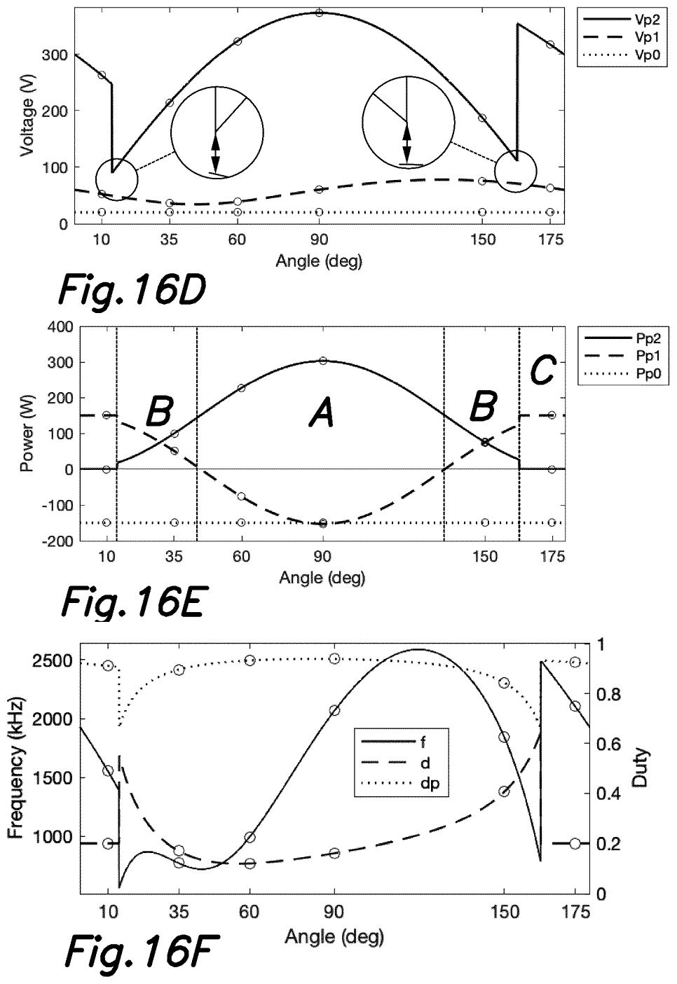

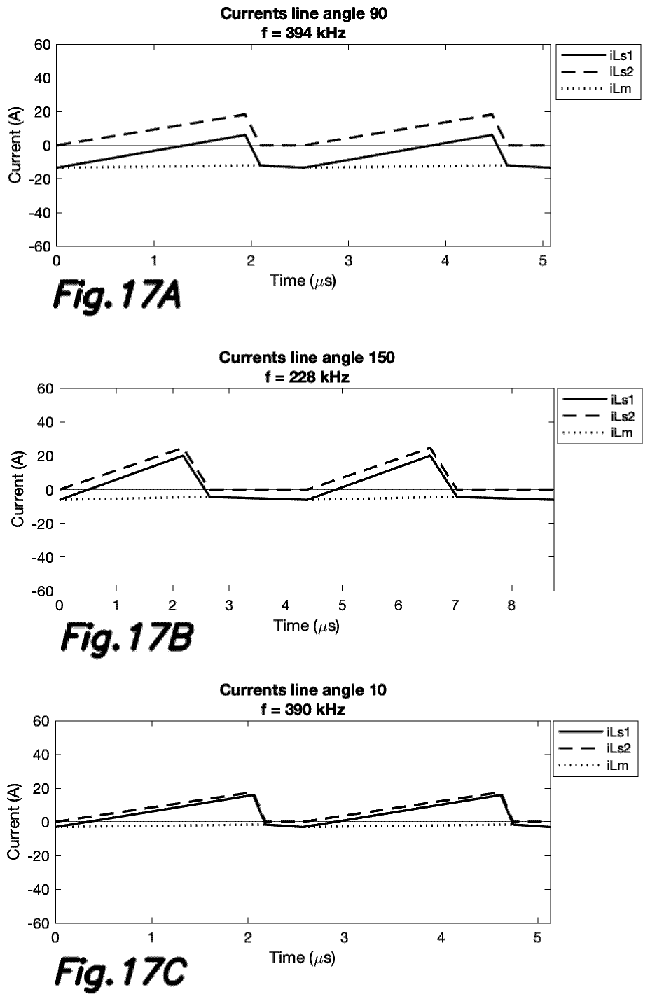

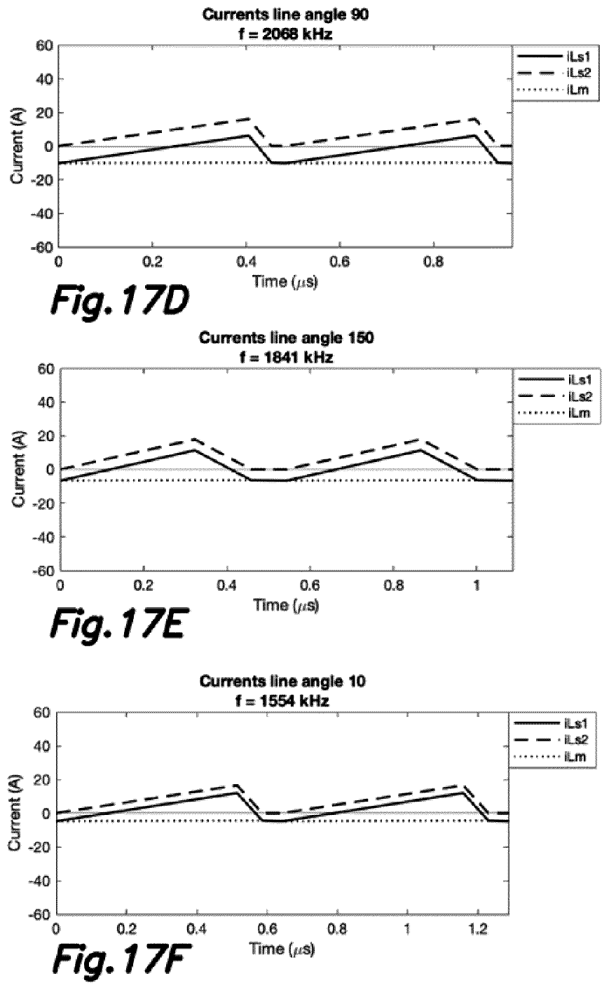

In FIG. 14B there is no capacitance 82 nor active clamp 62, 92 in any of the power switches 5,6

In FIG. 14C there is active clamp 61, 91 62, 92 in all the power switches 5,6 for a voltage in the DC port 201 equal to the output voltage in the DC port 200 in this equivalent circuit

In FIG. 14D there is active clamp 61, 91 62, 92 in all the power switches 5,6 for a voltage in the DC port 201 higher than the output voltage in the DC port 200 in this equivalent circuit

In FIG. 14E there is active clamp 61, 91 in the power switch 5, and a capacitance 82 in the power switch 6 of the additional DC port, for a voltage in the DC port 201 lower than the output voltage in the DC port 200 in this equivalent circuit

In FIG. 14F there is no capacitance 82 nor active clamp 62, 92 in any of the power switches 5,6. The output capacitance of any of the DC ports 201, 202 is a magnitude enough to produce a voltage resonance added to its mean voltage that produces a resonance in the current in the second inductance Lₛ₂ (7).

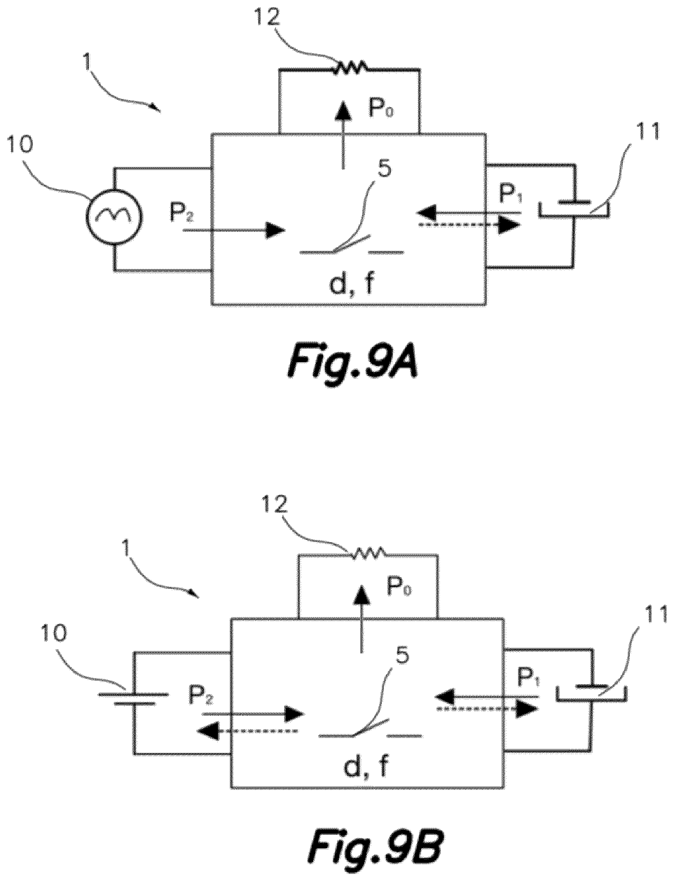

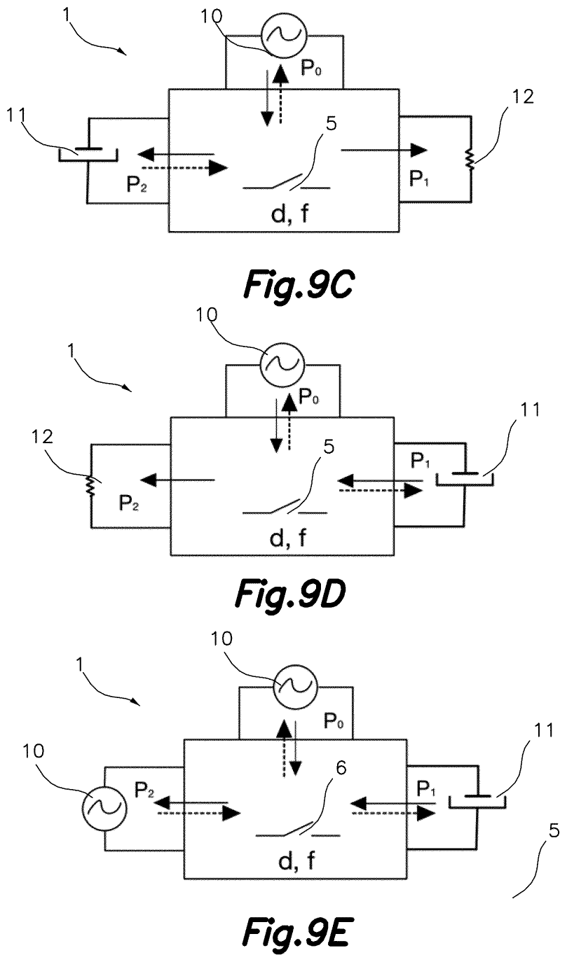

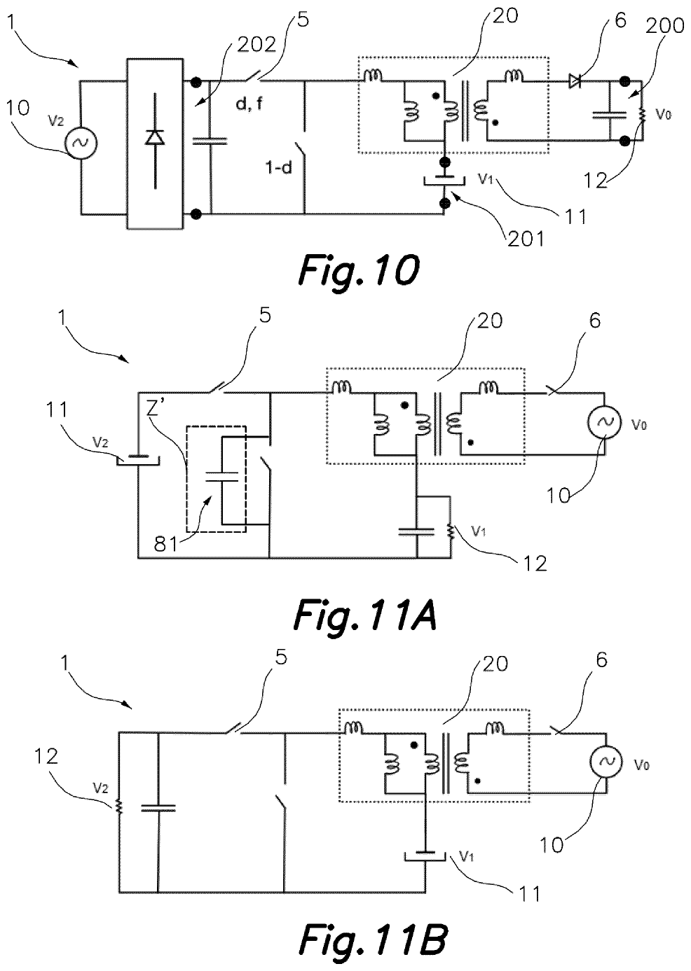

FIG. 15A to 15C show three operation modes of the switched mode power converter according to this invention using the embodiment of FIG. 9A or FIG. 10, wherein the switching frequency and duty cycle are controlled to provide a power flow according to three operative power pathways:
A. from AC input port (Port 202) the power flows to the load port (Port 200) and to the energy storage port (port 201);
B. from AC input port (Port 202) and the Energy storage port (Port 201) the power flows to the load port (Port 200); and
C. from the energy storage port (Port 201) the power flows to the load port (Port 200)

FIGS. 16A to 16F disclose the evolution of main magnitudes at line frequency illustrating the three operation modes described in FIGS. 15A to 15C for low and high AC input voltage.

Note that in operation mode “C”, the voltage in the port 202 is determined by the voltage gain of the synchronous buck, and not the rectified AC voltage, as would be expected in a typical diode bridge rectifier (as per the prior art).

FIGS. 17A to 17F disclose main current waveforms in the inductances at switching frequency, for the three operation modes described in FIGS. 15A to 15C and for high and low AC input voltage.

In the FIGS. 10 to 14A a further embodiment has been detailed comprising the optional addition of a capacitance in parallel with the power terminals of the power switch 5 of the primary side of the power converter. This alternative embodiment has been indicated inside a box labelled Z′ only shown in FIG. 11A. The previously indicated box Z′ and Z can also be further included in any of the embodiments of FIGS. 10 to 14A while it has not been depictured.

### DETAILED DESCRIPTION OF SEVERAL EMBODIMENTS

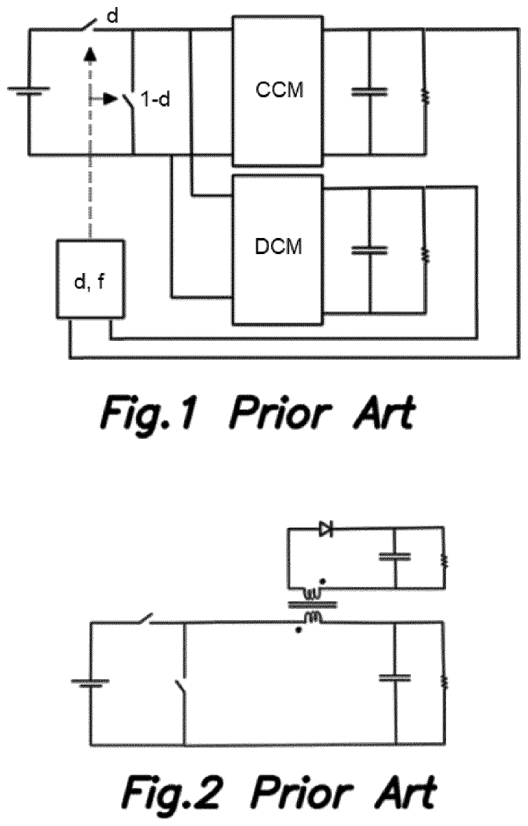

FIG. 1 illustrates a duty cycle and frequency control in a power converter as it is known in the state of the art in this technical field, showing more specifically two outputs of a DC-DC switched mode power converter that can be independently regulated. The inductance of one output operates in CCM and is regulated by adjusting the duty cycle. The inductance of the other output operates in DCM and is regulated by adjusting the switching frequency.

As per FIG. 2 an additional secondary output is connected to the inductance of a buck converter, described in the literature as operating in “Flyback” mode. This output is typically generated to supply auxiliary circuitry of the power converter, generating an auxiliary voltage which is proportional to the main output. The additional output is not independently regulated, just the opposite. The goal is to maintain proportionality and restrain cross-regulation. In fact, the leakage inductance of the transformer 20 is minimized, to maintain proportionality. There is only one control parameter, not two. In some variations, an additional controlled switch is added in the additional output to maintain the proportionality between the outputs, by delaying the conduction of this branch.

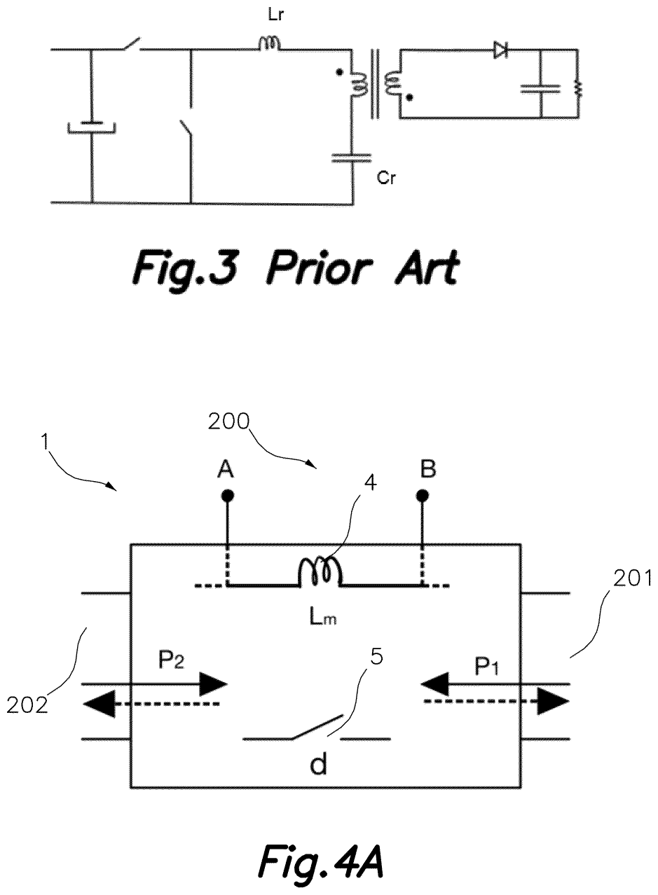

With reference to FIG. 3, a DC-DC converter as per an arrangement known in the art operates with resonant current, produced by a resonant capacitor in series with the transformer 20 and a resonant inductance, which is located in the primary side of the transformer 20. This resonant inductance may be the leakage inductance of the transformer 20 in the primary winding. There is only one control parameter, used to control the output voltage of the converter. This converter is widely used in AC-DC adapters. The input capacitor is large enough to perform the function of energy storage at line frequency (typically 50 Hz or 60 Hz). The mean voltage of the resonant capacitor is not controlled because its voltage is the mean voltage of the voltage in the power switch, which does not change.

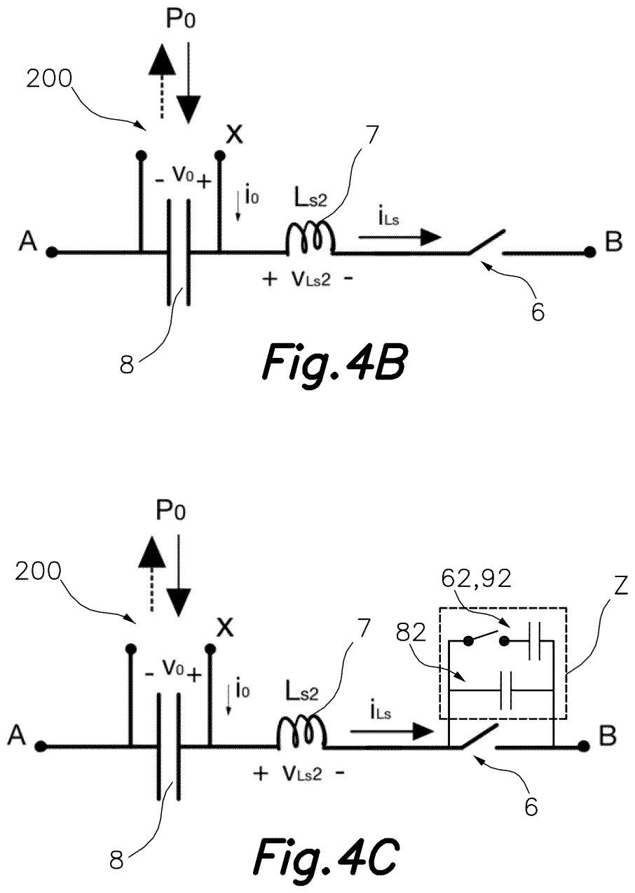

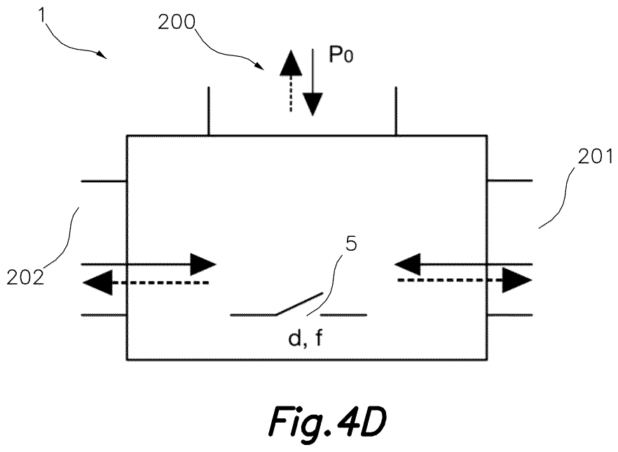

As previously disclosed, the present invention is based on a switched mode power converter that typically includes at least an inductance Lₘ, 4, to perform the power transfer (see FIG. 4a). The voltage applied to the inductance Lₘ, 4, is typically a periodic waveform with positive (V⁺) and negative (V⁻) levels. The ports 201 and 202 may be bi-directional, and the voltage gain is typically controlled in PWM converters by the duty cycle of the main switch, at constant switching frequency in the range of kHz or MHz. In resonant converters, the gain is controlled by adjusting the switching frequency.

As previously indicated in the embodiment of FIG. 4b, an additional port 200 is added. The additional port 200 includes a controlled or un-controlled power switch 6 and a second inductance Lₛ₂ 7 operating in Discontinuous Conduction Mode (DCM) and an output capacitor (8). The inductance Lₛ₂ 7 operates in DCM and the power switch 6 may be unidirectional or bi-directional. The result is depictured in FIG. 4c showing a multi-port DC-DC converter. The power flow in the ports may be uni-directional or bi-directional. The voltage in the additional port 200 is adjusted by the switching frequency. For reference, the nomenclature of the ports is such that V₂>V₁.

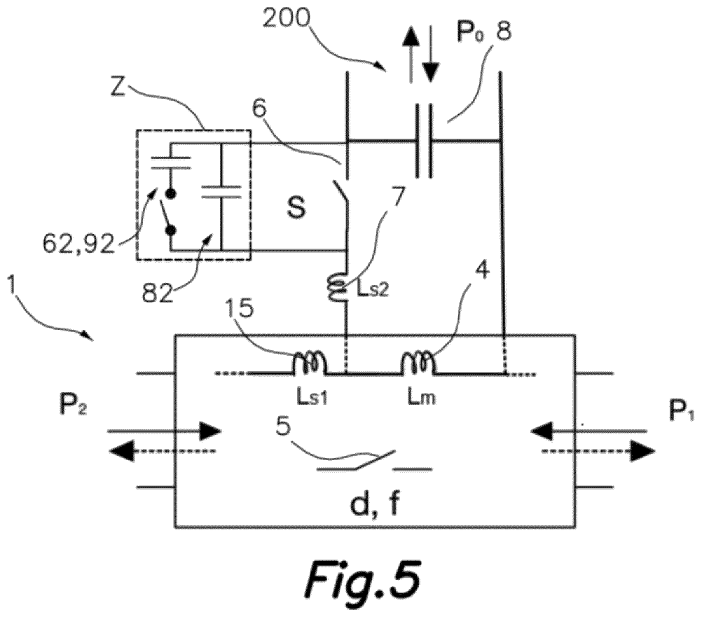

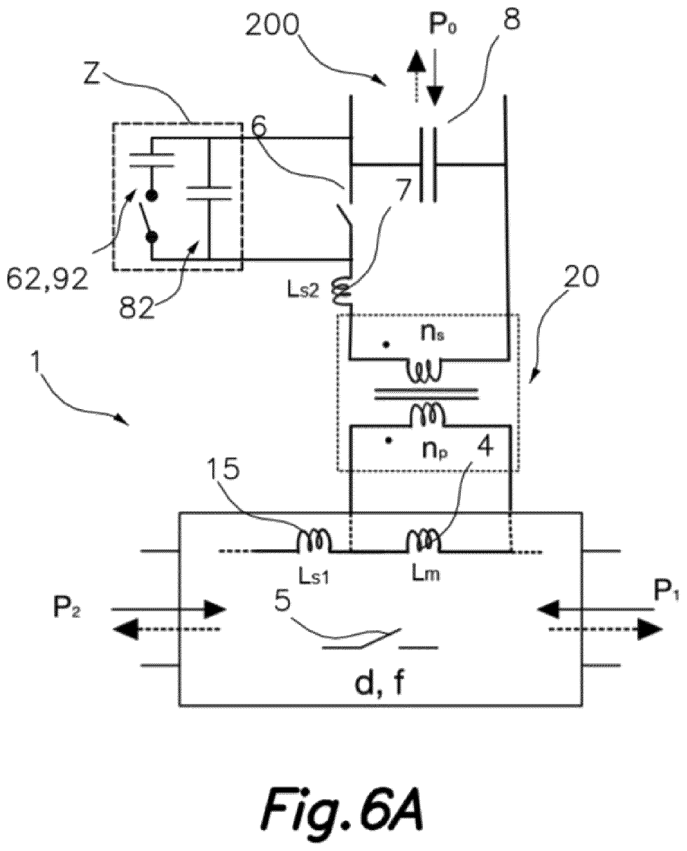

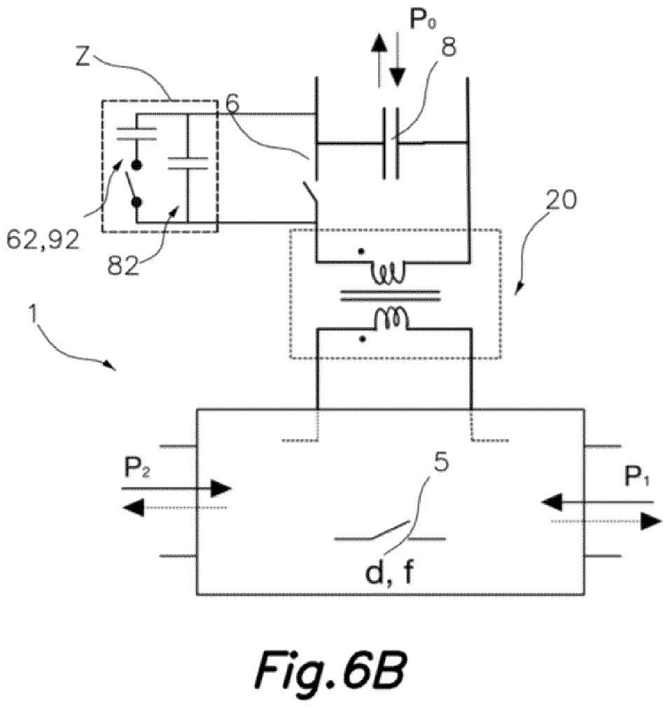

As illustrates FIG. 5 the switched mode power converter also operates properly adding the inductance Ls1, as described by the waveforms of FIG. 14 and adapting the calculation of the switching frequency to regulate the voltage in the additional port as described in equation.

$$\\ f = \frac{{V}_{0} \cdot {d}^{{}^{} ′}}{2 \cdot {P}_{o} \cdot {L}_{s 2}} \cdot ( {V}^{-} + {V}_{0} ) \cdot ( 1 - d )$$

Moreover, adding the inductance Lₛ₁, does not significantly change circuit operation. A Thévenin equivalent may be derived to calculate the relationship between the switching frequency and the output voltage in the additional port, v₀. This means that the voltage level in the transformer is slightly different, and also the output impedance of the equivalent circuit that drives the inductance Lₛ₂. The advantage of adding Lₛ₁ is that, together with Lₘ, and Lₛ₂, its combined functionality may be also achieved by a single transformer. The magnetizing inductance performs as Lₘ, and the leakage inductances perform as Lₛ₁ and Lₛ₂. This embodiment extends the functionality of claim 1 in the sense of providing both isolation and voltage and current transformation, provided by the transformer turns ratio.

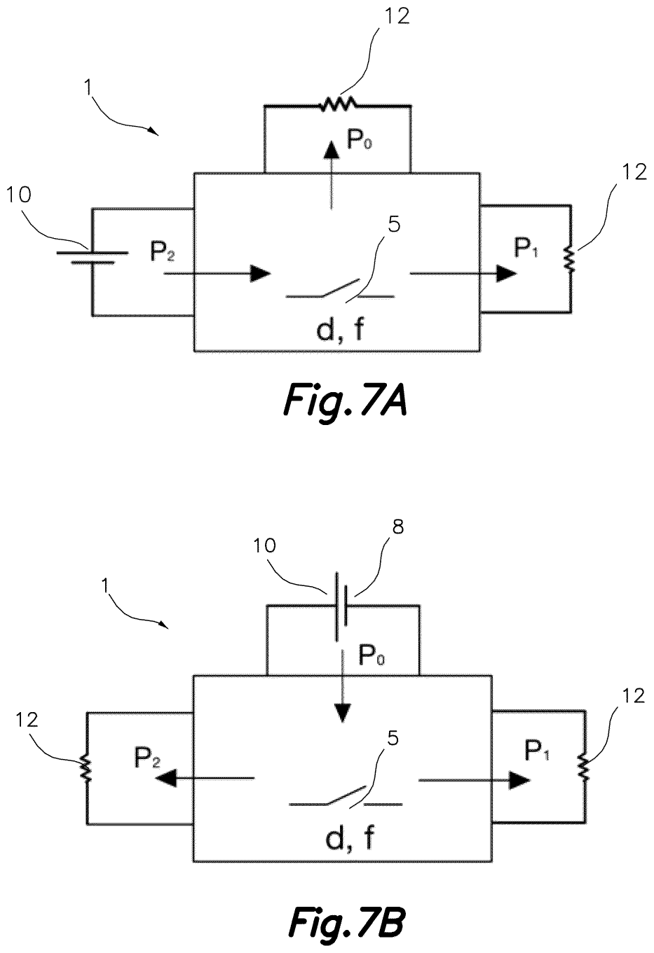

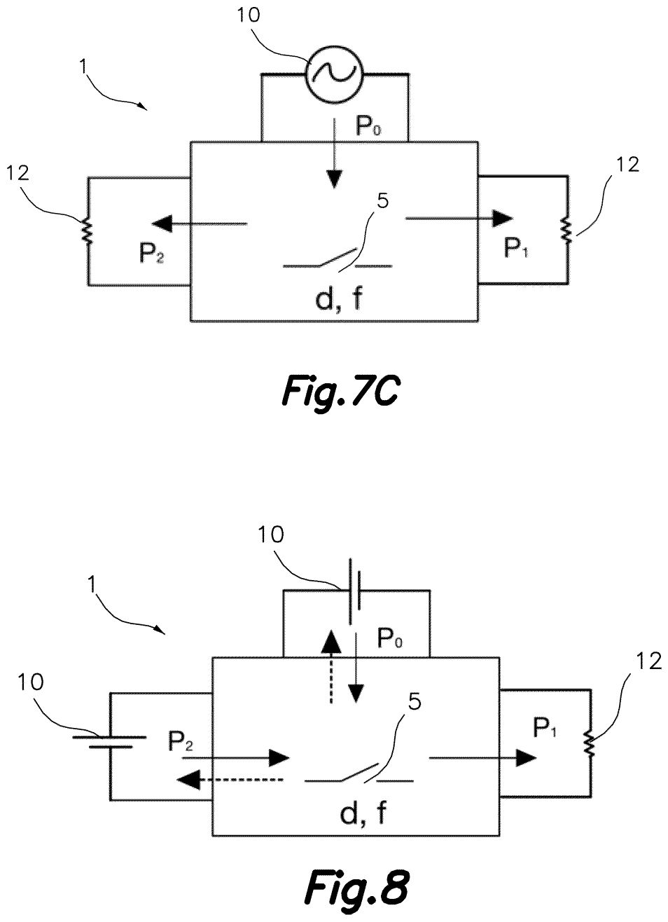

The embodiments of FIGS. 7A to 7C illustrate that the invention may be configured to supply two different loads, independently regulated by the duty cycle and the switching frequency, supplied from the same energy source, which may be connected to any port of the converter. The energy source may be either DC voltage or a low frequency AC voltage with regard to the switching frequency.

FIG. 8 illustrates an embodiment evidencing that the switched mode power converter may be configured to supply one single load, which receives energy from two different energy sources. The energy source may be either DC voltage or a low frequency AC voltage with regard to the switching frequency. The amount of power delivered by each energy source may be independently regulated by the duty cycle and the switching frequency.

The embodiments detailed in FIGS. 9A to 9E illustrate that the invention may be configured to include an energy buffer. The energy source, the energy buffer and the load may be connected to any port. The energy source may be either DC voltage or a low frequency AC voltage with 30 regard to the switching frequency. The amount of power delivered to the load and its voltage are regulated by either the duty cycle or the switching frequency. The not selected control variable may be used to shape or condition the current provided by the energy source. An additional control loop may be added to adjust the amplitude of the input current by controlling the mean voltage in the port used as energy storage.

The embodiments of FIGS. 10, 11A and 11B refers to a configuration based on a synchronous buck converter to regulate the voltage gain and the power flow between port 202 and port 201. The magnetizing inductance of the transformer is also the inductance of the buck converter and operates in continuous conduction mode (CCM). The duty cycle may be controlled so that the shape of the input power provided by the AC energy source rectified and connected to port 202 produces a high-power factor whereas it also regulates the mean DC voltage at the energy storage port (Port 201). The switching frequency of the power converter may regulate the output voltage applied to the load in the additional port, Port 200. The additional port includes a diode as a power switch, which may be replaced by a synchronous controlled transistor to reduce losses and increase efficiency.

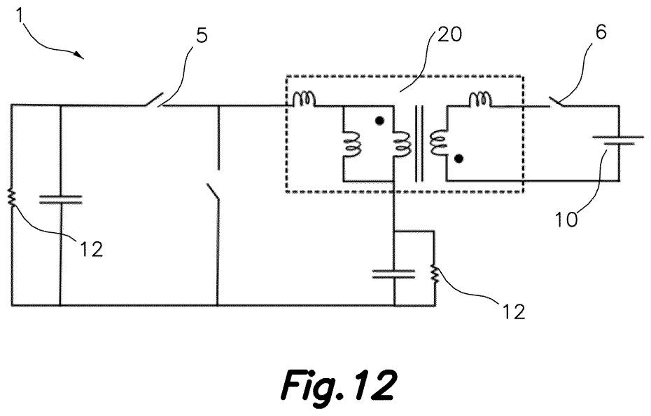

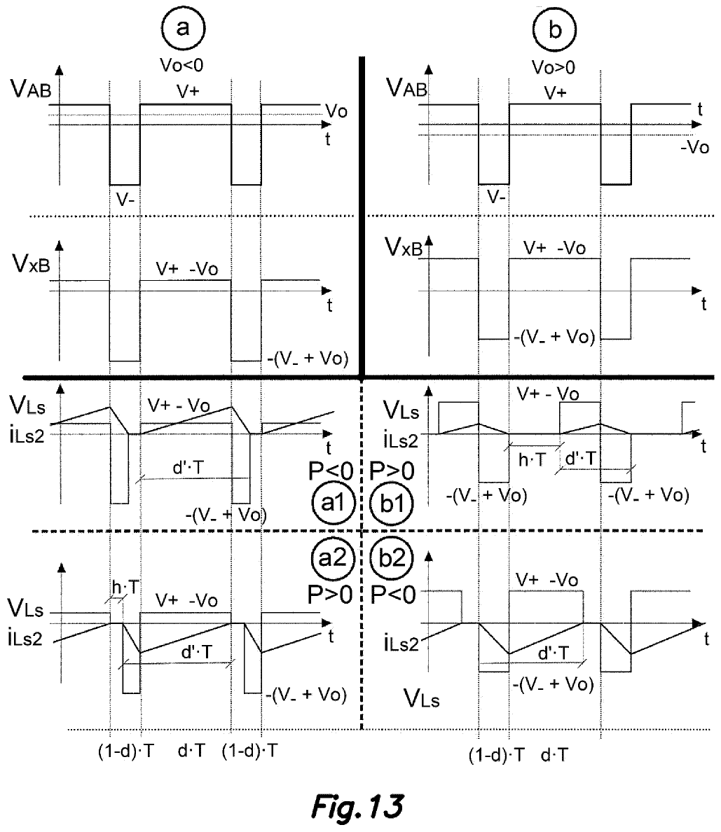

In the embodiment of FIG. 12 a synchronous buck converter regulates the voltage gain and the power flow between port 202 and port 201. The magnetizing inductance of the transformer is also the inductance of the buck converter and operates in continuous conduction mode (CCM). Two different loads are connected to these two ports 202 and 201, indistinctively. The duty cycle of the power converter regulates the voltage gain and power flow between these two ports. The switching frequency may be controlled to regulate the voltage gain between these two ports 202 and 201 and a DC voltage connected to the additional port 200. The additional port may include either a uni-directional or a bi-directional power switch, depending on the power flow.

The key waveforms describing the operation of the switched mode power converter of this invention have been represented in FIG. 13.

Voltage V_{AB} represents the voltage waveform applied to the inductance Lₘ. This voltage alternates at least between a positive (V⁺) and negative (V⁻) levels, although it might include other voltage levels, including zero. The average voltage of this inductance, as in any other inductance operating in a steady state in a power converter, is zero. An example in case of a buck converter is V⁺=Vᵢₙ−Vₛ and V⁻=Vₛ being Vᵢₙ the input voltage and Vₛ the output voltage of the power converter.

Any output voltage Vₛ may be obtained between these two voltage levels, positive (V⁺) and negative (V⁻).

Voltage V_{xB} is the voltage in the inductance minus the output voltage, that is V_{xB}=V_{AB}+V₀. It represents the voltage available to drive the additional inductance Lₛ₂.

Four operation modes a₁, a₂, b₁, b₂ at switching frequency, may be implemented, according to:
Whether the voltage in the additional port, Vₒ, is positive (b₁, b₂) or negative (a₁, a₂),
Whether the power in the additional port, Pₒ is positive (b₁, a₂) or negative (a₁, b₂)

Let “S_{d}” be the main power switch of the power converter (1). d is its duty cycle, and dT refers to the time this switch is conducting in each switching cycle, and therefore producing a positive voltage between the nodes A and B, that is V_{AB}>0.

The inductance Lₛ₂ operates in Discontinuous Conduction Mode (DCM), and is driven as described below, in each of the four operation modes:
Mode a₁ (Vₒ<0 and Pₒ<0): The port behaves as a load because the power is negative (flowing out of the power converter). The current Lₛ₂ in the inductance Lₛ₂ increases, since the voltage applied is V⁺−V₀, starting at zero, in synchronism with dT. At the time that S_{d} is turned OFF, the voltage applied to the inductance is negative −(V⁻+V₀) and the current decreases linearly to zero, remaining at this level until the next switching cycle, when S is turned ON again.

$$\\ f = \frac{{V}_{0} \cdot {d}^{{}^{} ′}}{2 \cdot {P}_{o} \cdot {L}_{s 2}} \cdot ( {V}^{+} - {V}_{0} ) \cdot d$$

Mode a₂ (V₀<0 and P₀>0): For the port to operate as an energy source (power flowing into the power converter), a delay fraction of time, hT, is required with regard to the time at which S_{d} turns OFF. The current i_{Ls2} in the inductance Lₛ₂ decreases as the voltage applied is −(V⁻+V₀), starting at zero in synchronism with (1−d)T plus the delay time hT. At the time that S is turned ON, the voltage applied to the inductance is positive, V⁺−V₀ and the current increases linearly to zero, remaining at this level until the next switching cycle. Note that h=1−d′

$$\\ f = \frac{{V}_{0} \cdot {d}^{{}^{} ′}}{2 \cdot {P}_{o} \cdot {L}_{s 2}} \cdot ( {V}^{-} + {V}_{0} ) \cdot ( 1 - d - h )$$

Mode b₁ (Vₒ>0 and Pₒ>0): For the port to operate as an energy source (power flowing into the power converter), a delay fraction of time, hT, is required with regard to the time at which S_{d} turns ON. The current i_{Ls2} in the inductance Lₛ₂ increases as the voltage applied is V⁺−V₀, starting at zero in synchronism with dT plus the delay time hT. At the time that S is turned OFF, the voltage applied to the inductance is negative, −(V⁻+V₀) and the current decreases linearly to zero, remaining at this level until the next switching cycle. Note that h=1−d′

$$\\ f = \frac{{V}_{0} \cdot {d}^{{}^{} ′}}{2 \cdot {P}_{o} \cdot {L}_{s 2}} \cdot ( {V}^{+} - {V}_{0} ) \cdot ( d - h )$$

Mode b₂ (Vₒ>0 and Pₒ<0): The port behaves as a load because the power is negative (flowing out of the power converter). The current i_{Ls2} in the inductance Lₛ₂ decreases as the voltage applied is −(V⁻+V₀), starting at zero, in synchronism with (1−d)T. At the time that S_{d} is turned ON, the voltage applied to the inductance is positive, V⁺−V₀ and the current increases linearly to zero, remaining at this level until the next switching cycle, when S_{d} is turned OFF again.

$$\\ f = \frac{{V}_{0} \cdot {d}^{{}^{} ′}}{2 \cdot {P}_{o} \cdot {L}_{s 2}} \cdot ( {V}^{-} + {V}_{0} ) \cdot ( 1 - d )$$

The switching frequency is the control parameter of this additional port, which may be calculated as a function of Lₛ₂ and all the operation conditions as illustrated in the formulae. These expressions for the frequency are derived calculating the average current flowing through the inductance, and relating this value with the output power, just multiplying by the load resistance.

In FIG. 14 a particular embodiment of the invention has been considered, being the power converter 1 a synchronous buck, and the power switch in the additional port is a diode. This power converter is also the equivalent circuit of the embodiment shown in FIG. 10.

The illustrated waveforms correspond to the operation mode b₂.

It can be seen that the waveforms are the same as those depicted in FIG. 13, being:

$$\\ {V}^{+} = {V}_{Th 1} = \frac{{V}_{1}}{n} \cdot \frac{{L}_{M}}{{L}_{M} \cdot {L}_{s 1}}$$

$$\\ {V}^{-} = {V}_{Th 2} = \frac{( {V}_{1} - {V}_{2} )}{n} \cdot \frac{{L}_{M}}{{L}_{M} \cdot {L}_{s 1}}$$

$$\\ {L}_{Th} = \frac{{L}_{M} \cdot {L}_{s 1}}{{L}_{M} + {L}_{s 1}}$$

$$\\ {L}_{eq} = {L}_{Th} + {L}_{s 2}$$

$$\\ d = \frac{{V}_{1}}{{V}_{2}}$$

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A PWM electrical switched-mode power converter, comprising:
a power switch;
two DC ports, each one being configured to flow power uni-directionally or bi-directionally and each one being controlled by a duty cycle of the power switch;
a first inductance Lₘ;
an additional DC port connected to the first inductance Lₘ in parallel, and comprising a series connection of:
a controlled or un-controlled power switch;
a second inductance Lₛ₂ configured to control a mean value of its current; and
an output capacitor,
a voltage of the additional DC port being controlled by a switching frequency of the PWM electrical switched-mode power converter;
the first inductance Lₘ being configured to perform power transfer in the PWM electrical switched-mode power converter, having a square voltage waveform that is configured to alternate between positive and negative values at the switching frequency of the PWM electrical switched-mode power converter, and having a mean value that is zero in steady state.

17. The PWM electrical switched-mode power converter according to claim 16, wherein at least one of a capacitance, a clamping capacitance and a clamping switch are connected in parallel with power terminals of the controlled or un-controlled power switch; a conduction time of the controlled or un-controlled power switch being maximized to reduce a RMS value of an input current, the conduction time being adjusted to operate the controlled or un-controlled power switch close to its technological limit, that is, its maximum breakdown voltage.

18. The PWM electrical switched-mode power converter according to claim 16, further comprising a third inductance Lₛ₁.

19. The PWM electrical switched-mode power converter according to claim 18, wherein the additional DC port further comprises a transformer configured to provide isolation to the additional port; magnetizing and leakage inductances of the transformer being configured to at least partially or completely replace the first inductance Lₘ, the second inductance Lₛ₂ and the third inductance.

20. The PWM electrical switched-mode power converter according to claim 16, wherein a first of the two DC ports or the additional DC port is connected to an energy source, the energy source being a DC voltage or a low frequency AC voltage with regard to the switching frequency of the PWM electrical switched-mode power converter; a load being connected to each of a second of the two DC ports and the additional DC port and their voltages being independently controlled by the duty cycle and the switching frequency of the PWM electrical switched-mode power converter.

21. The PWM electrical switched-mode power converter according to claim 16, wherein a first of the two DC ports is connected to a first energy source and the additional DC port is connected to a second energy source, the first and second energy sources being either a DC voltage or a low frequency AC voltage with regard to the switching frequency, and a load being connected to a second of the two DC ports, the load being configured to receive power from the first and second energy sources, the power being independently controlled by the duty cycle and the switching frequency of the PWM electrical switched-mode power converter.

22. The PWM electrical switched-mode power converter according to claim 16, wherein a first of the two DC ports is connected to an energy source, the energy source being a DC voltage or a low frequency AC voltage with regard to the switching frequency, a second of the two DC ports is configured to be used as energy storage providing a two-port energy buffered power converter storing energy changes at a rate controlled either by a selected duty cycle or by a selected switching frequency of the PWM electrical switched-mode power converter, and the additional DC port is connected to a load, a voltage of the load being regulated by a non-selected duty cycle or by a non-selected switching frequency of the PWM electrical switched-mode power converter.

23. The PWM electrical switched-mode power converter according to claim 22, wherein the duty cycle and the switching frequency are configured to control a DC voltage of the load, and to shape an input current in an AC or rectified AC voltage, whereby reducing a harmonic content of the input current.

24. The PWM electrical switched-mode power converter according to claim 16, which is based on a synchronous buck converter, wherein a first of the two DC ports is connected to an AC voltage through a rectifier bridge, and the additional DC port is connected to a load; the duty cycle being configured to control a shape of an input current, and an amplitude of the input current being adjusted by regulating a mean voltage of a second of the two DC ports, which is connected to an energy storage; a voltage applied to the load being regulated by the switching frequency.

25. The PWM electrical switched-mode power converter according to claim 16, which is based on a synchronous buck converter, wherein the additional DC port is connected to an AC voltage, a first of the two DC ports is configured to be used as an energy storage, and a second of the two DC ports is connected to a load, the controlled or un-controlled power switch being bi-directional, the switching frequency being configured to control a shape of an input current, an amplitude of the input current being adjusted by regulating a mean voltage of the first of the two DC ports used as energy storage, and a voltage applied to the load being regulated by the duty cycle.

26. The PWM electrical switched-mode power converter according to claim 16, wherein at least one of a capacitance and a clamping capacitance and a clamping switch are connected with the power terminals of the power switch in parallel.

27. The PWM electrical switched-mode power converter according to claim 16, wherein an output capacitance of any of the two DC ports comprises a magnitude configured to produce a voltage resonance added to its mean voltage that produces a resonance in the current in the second inductance Ls2.

28. A method to operate a PWM electrical switched-mode power converter, the PWM electrical switched-mode power converter comprising: a power switch; two DC ports, in which power in one of the two DC ports is configured to flow uni-directionally or bi-directionally, controlled by a duty cycle of the power switch; a first inductance Lₘ; an additional DC port, which is connected in parallel to the first inductance Lₘ, and comprises a series connection of a controlled or un-controlled power switch, a second inductance Lₛ₂ operated to control a mean value of its current, and an output capacitor, power transfer in the electrical switched-mode power converter being performed by the first inductance Lₘ, the method comprising:
controlling a voltage of the additional DC port by a switching frequency of the electrical switched-mode power converter, a square voltage waveform of the first inductance Lₘ alternating between positive and negative values at the switching frequency of the electrical switched-mode power converter, and a mean value of the first inductance Lₘ being zero in steady state.

29. The method according to claim 28, wherein a first of the two DC ports is connected to an energy source, the energy source being a low frequency AC voltage with regard to the switching frequency, a second of the two DC ports is configured to be used as energy storage providing a two-port energy buffered power converter storing energy changes at a rate controlled either by a selected duty cycle or by a selected switching frequency of the PWM electrical switched-mode power converter, and the additional DC port is connected to a load, a voltage of the load being regulated by a non-selected duty cycle or by a non-selected switching frequency of the PWM electrical switched-mode power converter, the duty cycle and the switching frequency controlling a DC voltage of the load and shaping an input current, the method further comprising controlling the switching frequency and duty cycle to provide a power flow according to three operative power pathways:
when an AC input voltage is higher than a given threshold, the power flows to the additional DC port that is connected to the load and the second of the two DC ports that is used as energy storage from the first of the two DC ports connected to the energy source;
when the input power is lower than the power demanded by the load, the power flows to the additional DC port that is connected to the load from the first of the two DC ports connected to the energy source and the second of the two DC ports used as energy storage; and
when the AC input voltage is lower than a given threshold, the power flows to the additional DC port that is connected to the load from the second of the two DC ports that is used as energy storage.

30. The method according to claim 29, further comprising adjusting a mean voltage of the second of the two DC ports that is used as energy storage using an RMS or peak voltage of the first of the two DC ports connected to the energy source, hence reducing power losses and improving performance of the PWM electrical switched-mode power converter.
